(19) United States
(12) Patent Application Publication
(10) Pub. No.: US 2007/0139101 A1
(43) Pub. Date: Jun. 21, 2007

(54) POWER SUPPLY CIRCUIT

(75) Inventors: TING-KAI WANG, Tu-Cheng (TW); Zhen-Hua Li, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,424

(22) Filed: Aug. 4, 2006

(30) Foreign Application Priority Data
Dec. 21, 2005 (CN) 200510121029.6

(51) Int. Cl. G05F 1/10

(52) U.S. Cl. 327/540

(57) ABSTRACT

An exemplary power supply circuit includes a comparator and two MOSFET transistors connected in parallel. The comparator has a non-inverting terminal connected to a reference voltage. Both gates of the MOSFET transistors are connected to an output terminal of the comparator, both drains of the MOSFET transistors are connected to a power supply, both sources of the two MOSFET transistors are connected to an inverting terminal of the comparator and act as an output of the power supply circuit.

### 1. FIELD OF THE INVENTION

The present invention generally relates to a power supply circuit, and more particular to a power supply circuit having a reduced response time.

### 2. DESCRIPTION OF RELATED ART

Referring to FIG. 2, a conventional power supply circuit is shown. The power supply circuit 100 includes two inputs 112 and 114, two comparators 131 and 132, two N-channel MOSFET transistors 133 and 134, and an output 152.

The input 112 is connected to a non-inverting terminal of the comparator 131, and an inverting terminal of the comparator 131 is connected to a source of the MOSFET transistor 133. An output terminal of the comparator 131 is connected to a gate of the MOSFET transistor 133. A drain of the MOSFET transistor 133 is connected to a power Vin, and the source of the MOSFET transistor 133 is connected to a drain of the MOSFET transistor 134. The input 114 is connected to a non-inventing terminal of the comparator 132, and an inverting terminal of the comparator 132 is connected to a source of the MOSFET transistor 134. An output terminal of the comparator 132 is connected to a gate of the MOSFET transistor 134. The source of the MOSFET transistor 134 is connected to the output 152.

The power Vin provides a 3.3V voltage. If a load connected to the output 152 needs a 1.8V voltage and a 2 A current, a voltage at the input 112 is clamped at 2.55V, and a voltage at the input 114 is clamped at 1.8V. The power supply circuit 100 is adjusted to provide a current of 2 A at the output 152. Moreover, a current increases to 5 A if a resistance of the load decreases. At the moment of the load decreasing, the current at the output 152 still remains 2 A, the voltage at the output 152 decreases, the voltage at the output terminal of the comparator 132 increases, the internal resistance of the MOSFET transistor 134 decreases, the voltage of the source of the MOSFET transistor 13 decreases, the voltage at the output terminal of the comparator 131 increases, and a drain current of the MOSFET transistors 133 increases. The current at the output 152 increases to 5 A, the voltage at the output 152 is 1.8V until the drain currents of the MOSFET transistors 133, 134 are equal to each other. The two MOSFET transistors 133 and 134 connected in series between the power Vin and the output 152 increase response time of the power supply circuit 100 when the resistance of the load changes, the longer response time may lead to abnormal performance of the load.

What is needed is a power supply circuit with a reduced response time of the power supply circuit when the resistance of the load changes.

### SUMMARY OF THE INVENTION

In one preferred embodiment, an exemplary power supply circuit includes a comparator and two MOSFET transistors connected in parallel. The comparator has a non-inverting terminal connected to a reference voltage. Both gates of the MOSFET transistors are connected to an output terminal of the comparator, both drains of the MOSFET transistors are connected to a power supply, and both sources of the two MOSFET transistors are connected to an inverting terminal of the comparator and act as an output of the power supply circuit.

Other advantages and novel features will become more apparent from the following detailed description when taken in conjunction with the accompanying drawings, in which:

### BRIEF DESCRIPTION OF THE DRAWINGS

FIG. 1 is a circuit diagram of a power supply circuit in accordance with a preferred embodiment of the present invention; and

FIG. 2 is a circuit diagram of a conventional power supply circuit.

### DETAILED DESCRIPTION OF THE INVENTION

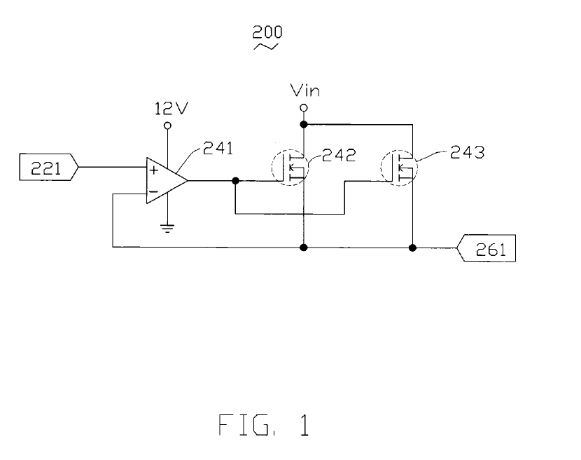

Referring to FIG. 1, a power supply circuit 200 in accordance with a preferred embodiment of the present invention includes an input 221, a comparator 241, two MOSFET transistors 242 and 243, and an output 261.

The input 221 is connected to a non-inverting terminal of the comparator 241, and an inverting terminal of the comparator 241 is coupled to a source of the MOSFET transistor 242, and a source of the MOSFET transistor 243. A reference voltage is input at the input 221. An output terminal of the comparator 241 is connected to gates of the two MOSFET transistors 242 and 243. Both drains of the two MOSFET transistors 242 and 243 are connected to a power Vin. The output terminal of the comparator 241 is connected to the output 261, and a load is connected to the output 261. A power pin of the comparator 241 is connected to a 12V power source, and a ground pin of the comparator 241 is grounded.

In this embodiment, the power Vin provides a 3.3V voltage, and the reference voltage is 1.8V.

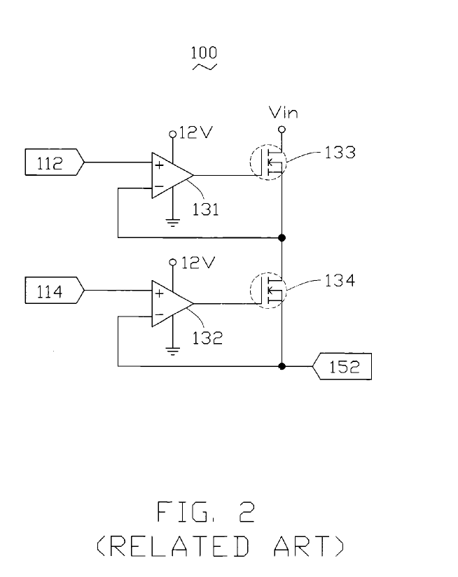

If the load connected at the output 261 needs a 1.8V voltage and a 2 A current, a 1.8V reference voltage is provided at the input 112. The power supply circuit 200 is adjusted to provide a current of 2 A at the output 261. However, current needs to increase up to 5 A if a resistance of the load decreases. At the moment of the load decreasing, the current at the output 261 still remains 2 A, the voltage at the output 261 decreases, the voltage at the output terminal of the comparator 241 increases, the internal resistances of the MOSFET transistors 242 and 243 decrease, drain currents of the MOSFET transistors 242 and 243 are increased. The current at the output 261 is increased to 5 A, the voltage at the output 261 increases to 1.8V. The two MOSFET transistors 242 and 243 connected in parallel between the power Vin and the output 261 decrease response time of the power supply circuit 200, when the resistance of the load changes, to approximately half that when MOSFET transistors are connected in series as in the conventional power circuit of FIG. 2.

It is to be understood, however, that even though numerous characteristics and advantages of the present embodiments have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power supply circuit comprising:
a comparator having a non-inverting terminal connected to a reference voltage, an inverting terminal, and an output terminal; and
two MOSFET transistors connected in parallel, both gates of the MOSFET transistors connected to the output terminal of the comparator, both drains of the MOSFET transistors connected to a power supply, both sources of the two MOSFET transistors connected to the inverting terminal of the comparator and acting as an output of the power supply circuit.

2. The power supply circuit as claimed in claim 1, wherein the MOSFET transistors are N-channel MOSFET transistors.
